(19) United States
(12) Patent Application Publication
(10) Pub. No.: US 2002/0194384 A1
(43) Pub. Date: Dec. 19, 2002

(54) Ad hov networks comprinsing a plurlity of terminals for determining terminals as controllers of sub-networks

(76) Inventor: Joerg Habetha, Aachen (DE)

Correspondence Address: Michael E Marion, Corporate Patent Counsel, Philips Electronics North america Corporation, Tarrytown, NY, 10591, US

(21) Appl. No.: 10/169,349

(22) PCT Filed: Oct. 24, 2001
(86) PCT No.: PCT/EP01/12410

(30) Foreign Application Priority Data
Oct. 30, 2000 (DE) 100 53 809.6

(51) Int. Cl. G06F 15/16

(52) U.S. Cl. 709/249; 709/220

(57) ABSTRACT

The invention relates to an ad hoc network comprising a plurality of terminals for determining terminals as controllers for controlling at least two sub-networks. An identification is assigned to each terminal. A terminal transmits its identification to the other terminals which are located in a predefined area. The terminal having the largest identification is provided to be the controller of a first sub-network. A certain number of further terminals having the lowest identifications are assigned to the first sub-network. The non-integrated terminal having the highest-but-one identification is provided to be the controller of a second sub-network. A certain number of further non-integrated terminals having the lowest identifications are assigned to the second sub-network.

The invention relates to an ad hoc network comprising a plurality of terminals for determining terminals as controllers for controlling at least two sub-networks. Such ad hoc networks are self-organizing and may comprise, for example, a plurality of sub-networks.

The document “J. Habetha, A. Hettich, J. Peetz, Y. Du: Central Controller Handover Procedure for ETSI-BRAN HIPERLAN/2 Ad Hoc Networks and Clustering with Quality of Service Guarantees, 1^{st} IEEE Annual Workshop on Mobile Ad Hoc Networking & Computing, Aug. 11, 2000 ”, discusses an ad hoc network comprising a plurality of terminals. At least one terminal is provided to be a controller for controlling the ad hoc network. Under certain conditions it may be necessary for another terminal to become a controller. For determining a new controller, inter alia the LDV and the ICT method are proposed. With the LDV method (LDV=Lowest Distance Value), each terminal calculates the sum of the distances to its respective neighboring terminals and divides this sum by the number of the neighboring terminals. The terminal having the lowest value becomes the new controller. With the ICT method (ICT=Highest In-Cluster Traffic), the terminal that has the highest traffic with the neighboring terminals is selected as the controller.

It is an object of the invention to provide a network that has measures for finding a terminal with a control function (controller) in a simple manner.

The object is achieved by a network of the type defined in the opening paragraph by the following measures:

an ad hoc network comprising a plurality of terminals for determining terminals as controllers for controlling at least two sub-networks,

to each of which terminals an identification is assigned,

which terminals are provided for transmitting their identification to the other terminals located in a predefined area,

of which terminals the terminal having the largest identification is provided to be a controller of a first sub-network,

a certain number of further terminals having the lowest identifications are assigned to the first sub-network,

of which the non-integrated terminal having the highest-but-one identification is provided to be a controller of a second sub-network and

a certain number of further terminals together with the non-integrated terminals having the lowest identifications are assigned to the second sub-network.

According to the invention a terminal having the highest identification becomes the controller of a first sub-network. A controller is a terminal that performs control functions in a sub-network. A certain number of terminals having the lowest identifications are integrated in the first sub-network. The number of terminals to be integrated in a sub-network may depend, for example, on the transmission capacity in the sub-network. A second sub-network is opened if there are still non-integrated or free terminals. From the free terminals the terminal having the highest identification, thus the terminal that has the highest-but-one identification in the predefined area becomes the controller. The predefined area may be, for example, the area in which the terminals waiting for being integrated in a sub-network can exchange data directly. In the second sub-network are then integrated a certain number of free terminals having the lowest identifications.

Further non-integrated terminals having the highest identifications are provided to be controllers of further sub-networks. A certain number of further non-integrated terminals having the lowest identifications are assigned to the further sub-networks. A reconfiguration of a sub-network or of the whole network is necessary when a controller of a sub-network detects a terminal that has a higher identification. In that case the controller function is handed over to the terminal that has the higher identification.

The controller of each sub-network can also exchange data via bridge terminals which connect at least two sub-networks. In the event of a change within the network a controller then starts a reconfiguration of at least one sub-network on the basis of the data exchanged between the controllers.

The invention also relates to a method of determining terminals as controllers for controlling at least two sub-networks in an ad hoc network.

The data which are transmitted in the network may be generated, for example, in accordance with a packet transmission method. The packets may be transmitted over the wireless medium as whole packets or as sub-packets after further information has been affixed. A wireless transmission is understood to mean a radio, infrared or ultra-shell transmission etc. As a packet transmission method may be used, for example, the asynchronous transfer mode (ATM), which generates packets of fixed length which are called cells.

These and other aspects of the invention are apparent from and will be elucidated with reference to the embodiments described hereinafter.

In the drawings:

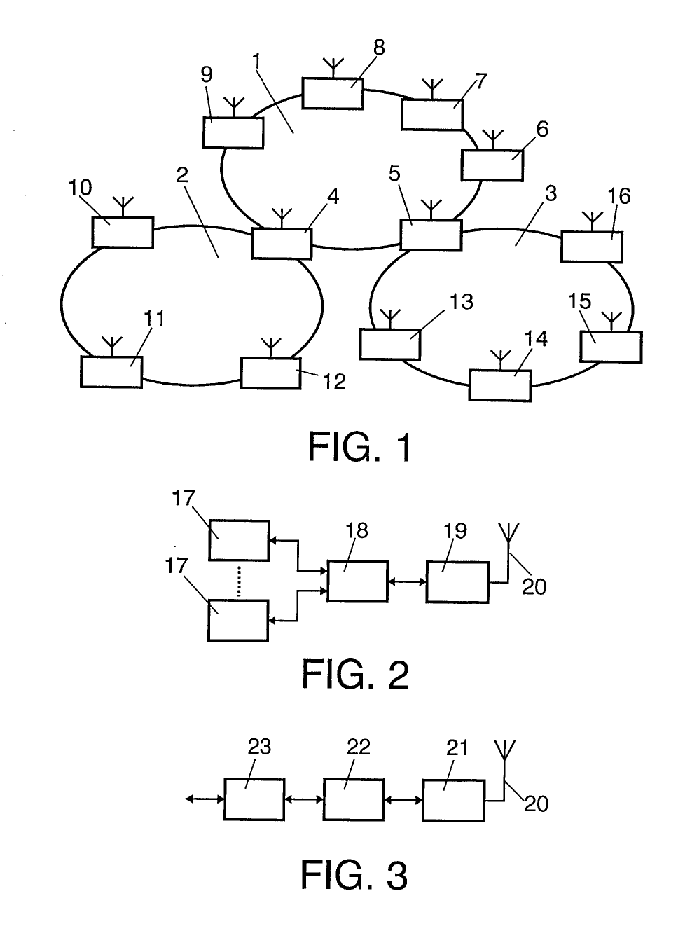

FIG. 1 shows an ad hoc network comprising three sub-networks which each contain terminals provided for radio transmission,

FIG. 2 shows a terminal of the local area network as shown in FIG. 1,

FIG. 3 shows a radio device of the terminal shown in FIG. 2,

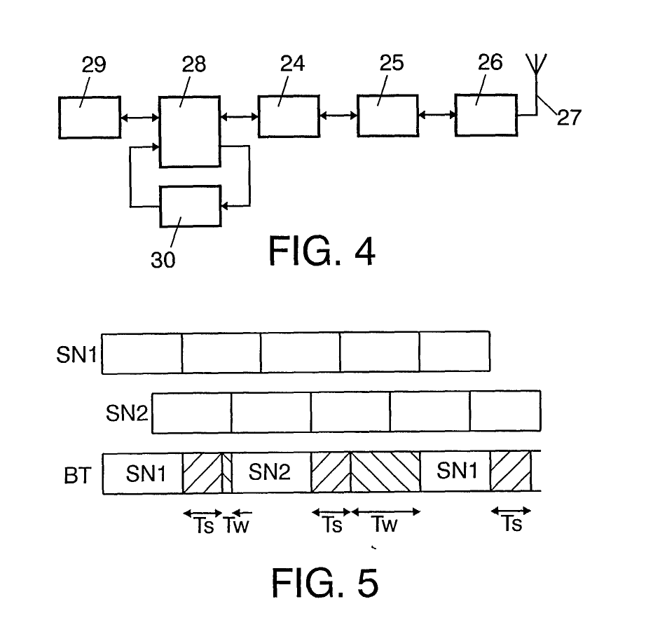

FIG. 4 shows an embodiment of a bridge terminal provided as a connection between two sub-networks,

FIG. 5 shows MAC frames of two sub-networks and the MAC frame structure of a bridge terminal.

The example of embodiment shown in the following relates to ad hoc networks which are self-organizing, which is in contrast to traditional networks. Each terminal in such an ad hoc network may make access possible to a fixed network and can immediately be used. An ad hoc network is characterized in that the structure and the number of subscribers are not fixed within predefined limit values. For example, a subscriber's communication device may be removed from the network or included therein. Contrary to traditional mobile radio networks, an ad hoc network is not limited to a fixedly installed infrastructure.

The size of the area of the ad hoc network is usually much larger than the transmission range of one terminal. A communication between two terminals may therefore require that further terminals be switched on, so that these messages or data can be transmitted between the two communicating terminals. Such ad hoc networks, in which a transfer of messages and data over a terminal is necessary, are referred to as multihop ad hoc networks. A possible organization of an ad hoc network consists of regularly forming sub-networks or clusters. A sub-network of the ad hoc network can be formed, for example, by terminals connected via radio paths of subscribers sitting at a table. Such terminals may be, for example, communication devices for the wireless exchange of messages, pictures and so on.

There may be two types of ad hoc networks. They are decentralized and centralized ad hoc networks. In a decentralized ad hoc network the communication between the terminals is decentralized, that is to say, each terminal can directly communicate with any other terminal, provided that the terminals are located within the transmission range of the other terminal. The advantage of a decentralized ad hoc network is its simplicity and robustness to errors. In a centralized ad hoc network, certain functions such as, for example, the function of multiple access of a terminal to the radio transmission medium (Medium Access Control=MAC) is controlled by one specific terminal per sub-network. This terminal is referred to as central terminal or central controller (CC). These functions need not always be carried out by the same terminal, but can be handed over by a terminal acting as a central controller to another terminal then acting as a central controller. The advantage of a centralized ad hoc network is that in this network an agreement about the quality of service (QoS) is possible in a simple manner. An example for a centralized ad hoc network is a network that is organized according to the HiperLAN/2 Home Environment Extension (HEE) (compare J. Habetha, A. Hettich, J. Peetz, Y. Du, “Central Controller Handover Procedure for ETSI-BRAN HIPERLAN/2 Ad Hoc Networks and Clustering with Quality of Service Guarantees”, 1^{st} IEEE Annual Workshop on Mobile Ad Hoc Networking & Computing, Aug. 11, 2000).

FIG. 1 shows an example of embodiment of an ad hoc network having three sub-networks 1 to 3, which each contain a plurality of terminals 4 to 16. Constituent parts of the sub-network 1 are the terminals 4 to 9, of the sub-network 2 the terminals 4 and 10 to 12, and of the sub-network 3 the terminals 5 and 13 to 16. In a sub-network the terminals belonging to a respective sub-network exchange data over radio paths. The ellipses shown in FIG. 1 indicate the radio coverage of a sub-network (1 to 3), in which a largely problem-free radio transmission is possible between the terminals belonging to the sub-network.

The terminals 4 and 5 are called bridge terminals, because they enable an exchange of data between two sub-networks 1 and 2 or 1 and 3, respectively. The bridge terminal 4 is used for the data traffic between the sub-networks 1 and 2 and the bridge terminal 5 for the data traffic between the sub-networks 1 and 3.

A terminal 4 to 16 of the local area network shown in FIG. 1 may be a mobile or fixed communication device and comprises, for example, at least a station 17, a connection controller 18 and a radio device 19 with an antenna 20, as shown in FIG. 2. A station 17 may be, for example, a portable computer, telephone and so on and so forth.

A radio device 19 of the terminals 6 to 16 comprises, as shown in FIG. 3, in addition to the antenna, a high-frequency circuit 21, a modem 22 and a protocol device 23. The protocol device 23 forms packet units from the data stream received from the connection controller 18. A packet unit contains parts of the data stream and additional control information formed by the protocol device 23. The protocol device uses protocols for the LLC layer (LLC=Logic Link Control) and the MAC layer (MAC=Medium Access Control). The MAC layer controls the multiple access of a terminal to the radio transmission medium and the LLC layer carries out a flow and error control.

As observed above, in a sub-network 1 to 3 of a centralized ad hoc network, a specific terminal is responsible for the control and management functions and is referred to as central controller. The controller furthermore works as a normal terminal in the associated sub-network. The controller is responsible, for example, for the registration of terminals that operate in the sub-network, for the connection set-up between at least two terminals in the radio transmission medium, for the resource management and for the access control in the radio transmission medium. For example, after the registration and announcement of a transmission request a terminal of a sub-network is assigned transmission capacity for data (packet units) by the controller.

In the ad hoc network, the data can be exchanged between the terminals in accordance with a TDMA, FDMA or CDMA method (TDMA=Time Division Multiple Access, FDMA=Frequency Division Multiple Access, CDMA=Code Division Multiple Access). The methods may also be combined. To each sub-network 1 to 3 of the local area network are assigned a number of specified channels which are referred to as a channel group. A channel is determined by a frequency range, a time range and, for example in CDMA methods, by a spreading code. For example, each sub-network 1 to 3 can have a certain, respectively different frequency range available for the data exchange, which range has a carrier frequency f₁. In such a frequency range may be transmitted, for example, data by means of the TDMA method. The sub-network 1 may then be assigned the carrier frequency f₁, the sub-network 2 the carrier frequency f₂ and the sub-network 3 the carrier frequency f₃. The bridge terminal 4 works at the carrier frequency f₁, on the one hand, to carry out an exchange of data with the other terminals of the sub-network 1 and, on the other hand, at the carrier frequency f₂, to carry out a data exchange with the other terminals of the sub-network 2. The second bridge terminal 5 contained in the local area network, which bridge terminal 5 transmits data between the sub-networks 1 and 3, works at the carrier frequencies f₁ and f₃.

As observed above, the central controller has, for example, the function of access controller. This means that the central controller is responsible for the formation of frames of the MAC layer (MAC frames). For this purpose the TDMA method is used. Such a MAC frame has various channels for control information and useful data.

A block diagram of an example of embodiment of a bridge terminal is shown in FIG. 4. The radio switching device of this bridge terminal comprises a protocol device 24, a modem 25 and a high-frequency circuit 26 with an antenna 27. To the protocol device 24 is connected a radio switching device 28, which is further connected to a connection controller 29 and a buffer arrangement 30. In this embodiment the buffer arrangement 30 contains one storage element and is used for buffering data and realized as a FIFO module (First In First Out), that is, the data are read from the buffer arrangement 30 in the order in which they were written. The terminal shown in FIG. 4 may also work as a normal terminal. Stations not shown in FIG. 4, but connected to the connection controller 29, then supply data to the radio switching device 28 via the connection controller 29.

The bridge terminal shown in FIG. 4 is alternately synchronized with a first and a second sub-network. Synchronization is understood to mean the entire process of integrating a terminal with the sub-network for the exchange of data. If the bridge terminal is synchronized with the first sub-network, it can exchange data with all the terminals and with the controller of this first sub-network. If the connection controller 29 supplies data to the radio switch device 28, the destination of which data is a terminal or the controller of the first sub-network, or a terminal or controller of another sub-network that can be reached via the first sub-network, the radio switch device conveys these data directly to the protocol device 24. In the protocol device 24 the data are buffered until the time slot is reached which the controller has intended to be used for the transmission. If the data coming from the connection controller 29 are to be transmitted to a terminal or to the controller of the second sub-network, or to another sub-network to be reached via the second sub-network, the radio transmission is to be delayed until the time slot in which the bridge terminal is synchronized with the second sub-network. For this purpose, the radio switch device transports the data whose destination lies in the second sub-network, or whose destination can be reached via the second sub-network, to the buffer device 30, which buffers the data until the bridge terminal is synchronized with the second sub-network.

If data from a terminal or the controller of the first sub-network are received by the bridge terminal and their destination is a terminal or the controller of a second sub-network, or a terminal or controller of another sub-network to be reached via the second sub-network, these data are stored in the buffer device 30 until the synchronization with the second sub-network. Data whose destination is a station of the bridge terminal are directly conveyed to the connection controller 29 via the radio switch device 28, which controller then leads the received data to the desired station. Data whose destination is neither a station of the bridge terminal nor a terminal or controller of the second sub-network, are sent, for example, to a further bridge terminal.

After the change of synchronization of the bridge terminal from the first to the second sub-network, the data located in the buffer device 30 are read out again from the buffer device 30 in the order in which they have been written. Subsequently, during the time when the bridge terminal is synchronized with the second sub-network, all the data whose destination is a terminal or the controller of the second sub-network, or another sub-network to be reached via the second sub-network, are immediately conveyed to the protocol device 24 by the radio switch device 28, and only the data whose destination is a terminal or the controller of the first sub-network, or another sub-network to be reached via the first sub-network, are stored in the buffer device 30.

The MAC frames of two sub-networks SN1 and SN2 are usually not synchronized. Therefore, a bridge terminal BT is not only connected to a sub-network SN1 or SN2 during a change-over time Ts, but also during a waiting time Tw. This can be learnt from FIG. 5, which shows a sequence of MAC frames of the sub-networks SN1 and SN2 and the MAC frame structure of the bridge terminal BT. The change-over time Ts is the time that is necessary for the bridge terminal to be able to synchronize with the sub-network. The waiting time Tw indicates the time between the end of the synchronization with the sub-network and the beginning of a new MAC frame of this sub-network.

Assuming that the bridge terminal BT is connected to a sub-network SN1 or SN2 only for the duration of a MAC frame, the bridge terminal BT has only a channel capacity of ¼ of the available channel capacity of a sub-network. In the other extreme case, where the bridge terminal BT is connected to a sub-network for a longer period of time, the channel capacity is half the available channel capacity of a sub-network.

As described above, each sub-network includes a central controller for controlling the assigned sub-network. When a sub-network is taken into operation, it is to be ensured that only one terminal takes over the function of central controller. It is assumed that not any terminal can take over the function of central controller. When a central controller is determined, the procedure is, for example, that each terminal that can take over a function of controller checks whether in its receive range there is another terminal that can carry out the function of controller. If this is the case, the detecting terminal establishes that it does not become the controller. If all the other terminals also make this check, in the end there will be one terminal that detects no other terminal that has the function of controller and it thus takes over the function of controller.

It may happen that a sub-network is to be reconfigured. This may be because of the following reasons:

central controller switched off,

insufficient power conditions of the central controller,

poor connections of one or various terminals,

insufficient capacity conditions in one or various sub-networks,

new terminals to be integrated or switched off in the sub-network and

a terminal leaving the sub-network.

For reconfiguring or configuring at least one sub-network for the first time, the following procedure is used which is referred to as HID procedure (Highest-ID-with-traffic):

All the terminals have a unique identification (ID) in the network. Each terminal periodically distributes its identification to all the terminals in its transmission area. A terminal that has received identifications from various terminals compares its own identification with the identifications of the directly neighboring terminals (terminals lying in the transmission area). A terminal autonomously decides that it becomes the controller when its own identification is higher than any identification received from other terminals.

The HID procedure also provides that the terminal having the highest identification becomes the controller. This new controller connects its direct neighbors in the sub-network in ascending order beginning with the terminal having the lowest identification. A terminal can be integrated in a sub-network only when there is still transmission capacity available within the sub-network. If the whole available transmission capacity in the sub-network is used up, an additional sub-network is to be opened. In this additional sub-network the terminal having the highest-but-one identification becomes the controller. This terminal certainly has not been integrated with the first sub-network so far, because the integration of the terminals takes place in ascending order. Conversely, this means that when there are terminals not yet assigned to a sub-network, they will be the free terminals having the highest identifications. Further additional sub-networks are opened when there are still terminals available that have so far not been integrated in the available sub-networks. Like before, always the free terminal having the highest identification then becomes the controller to which the rest of the free terminals are assigned in the order of ascending identifications.

If the terminal having the highest-but-one identification cannot be integrated in the sub-network of the terminal having the highest identification, the terminal having the highest-but-one identification can detect this either in that its association attempt is rejected or in that a direct message is sent by the terminal having the highest identification. The terminal having the highest-but-one identification then verifies whether in comparison with all its direct free neighbors, it has the highest identification (free or non-associated terminals). If this is the case, it becomes an additional controller to include the neighboring terminals that are not yet assigned or still free. If after the opening of the new sub-network by the terminal having the highest-but-one identification there are still free terminals, a new sub-network is opened by the terminal having the highest identification, similarly to the procedure described above, which terminal having the highest identification has not yet been assigned to any sub-network. The re-opening of sub-networks and subsequent integration of free terminals is carried out until each terminal belongs to a sub-network.

After a first configuration, a reconfiguration of the network may be effected continuously as soon as a controller detects that there is another, directly neighboring terminal that has a higher identification than the controller. In that case the controller function is handed over to this neighboring terminal. The neighboring terminal or the new controller respectively, integrates all the terminals of the sub-network of the old controller in so far as they lie in its transmission area or its coverage range, respectively, and there are still free terminals in its new sub-network. The integration takes place, as described above, in ascending order of identifications. If, because of exhausted transmission capacity or because of the fact that there are no terminals in the coverage area of the new controller, nor that there are free terminals, the algorithm runs as described above. This means that the terminal having the highest-but-one identification establishes an additional sub-network and, if not all the free terminals can be integrated in this newly established sub-network, further sub-networks arise.

Alternatively, the reconfiguration may also take place locally or in the whole network in time intervals. A terminal would then send the signal for reconfiguration to all the other terminals (in the broadcasting mode), or all the terminals could individually start with the reconfiguration at certain (periodic) intervals, if there is a system-wide synchronized system time.

With the decentrally organized HID procedure described so far, it has been assumed that a terminal sends its identification only to its direct neighbors. These neighbors should not then transfer the received identification, that is to say, each terminal sends only its own identification in the broadcasting mode to its direct neighbors. However, also a central procedure carried out by the respective controllers could be carried out, in which, in case of a reconfiguration, the respective controllers control the new controller and the respective integration of the terminals in the assigned sub-network. The controllers then exchange the respective matrix information via bridge terminals. For example, each terminal of the network together with its neighboring terminals is then listed in a matrix and each old controller can determine on the basis of the matrix whether the current controller is also the new controller or whether another terminal becomes the new controller.

1. An ad hoc network comprising a plurality of terminals for determining terminals as controllers for controlling at least two sub-networks,
to each of which terminals an identification is assigned,
which terminals are provided for transmitting their identification to the other terminals located in a predefined area,
of which terminals the terminal having the largest identification is provided to be a controller of a first sub-network,
a certain number of further terminals having the lowest identifications are assigned to the first sub-network,
of which terminals the non-integrated terminal having the highest-but-one identification is provided to be a controller of a second sub-network, and
a certain number of further terminals together with the non-integrated terminals having the lowest identifications are assigned to the second sub-network.

2. An ad hoc network as claimed in claim 1, characterized in that further non-integrated terminals having the respective highest identification are provided to be controllers of further sub-networks and a certain number of further non-integrated terminals having the lowest identifications are assigned to the further sub-networks.

3. An ad hoc network as claimed in claim 1, characterized in that the certain number of terminals to be integrated in a sub-network depends on the transmission capacity in the sub-network.

4. An ad hoc network as claimed in claim 1, characterized in that a controller of a sub-network, after detection of a terminal having a higher identification, is provided for handing over the control function to the terminal having the higher identification.

5. An ad hoc network as claimed in claim 1, characterized in that the controllers of each sub-network are each provided for exchanging data via bridge terminals which connect at least two sub-networks and in that a controller in case of a change in the network is provided for starting a reconfiguration of at least one sub-network with the aid of the data exchanged between the controllers.

6. A method of determining terminals as controllers for controlling at least two sub-networks in an ad hoc network comprising a plurality of terminals
to each of which terminals an identification is assigned,
which terminals are provided for transmitting their identification to the other terminals located in a predefined area,
of which terminals the terminal having the largest identification is provided to be a controller of a first sub-network,
a certain number of further terminals having the lowest identifications are assigned to the first sub-network,
of which terminals the non-integrated terminal having the highest-but-one identification is provided to be a controller of a second sub-network, and
a certain number of further terminals together with the non-integrated terminals having the lowest identifications are assigned to the second sub-network.

7. Terminal in an ad hoc network comprising a plurality of other terminals for determining terminals as controller for controlling at least two sub-networks, in which
the terminal is provided for transmitting its identification to the other terminals located in a predefined area and for receiving the identification of the other terminals located in the predefined area,
the terminal is provided as controller of a first sub-network, if it has the highest identification,
the terminal is assigned to the first sub-network, if it belongs to a certain number of further terminals having the lowest identifications,
the terminal is provided as controller of a second sub-network, if it does not belong to the non-integrated terminals and has the highest-but-one identification, or
the terminal is assigned to the second sub-network, if it belongs to a certain number of further non-integrated terminals having the lowest identifications.
